(19) United States
(12) Patent Application Publication
(10) Pub. No.: US 2004/0205009 A1
(43) Pub. Date: Oct. 14, 2004

(54) System for calculating and identifying unique orders

(76) Inventors: Gary Patrick Noto, Austin, TX (US); Jack Lawrence Buckner, Austin, TX (US); Charles Edward Lemons, Cedar Park, TX (US); James Russell Van Artsdalen, Austin, TX (US)

Correspondence Address: HAMILTON & TERRILE, LLP, P.O. BOX 203518, AUSTIN, TX, 78720, US

(21) Appl. No.: 10/411,236

(22) Filed: Apr. 10, 2003

(51) Int. Cl. G06F 17/60

(52) U.S. Cl. 705/34

(57) ABSTRACT

A method for identifying unique orders. The method includes gathering part information for an ordered system, concatenating a string of the part information data for a given order type, and calculating a unique order information value from the string of part information data.

### BACKGROUND OF THE INVENTION

1. Field of the Invention

The present invention relates to the field of calculation for unique hardware and software orders.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more information handling systems, data storage systems, and networking systems.

It is known to install software and to perform tests on information handling systems before they are shipped to businesses or individual customers. A goal of software installation is to efficiently produce a useful, reliable information handling system. Software installation often includes loading a desired package of software onto the information handling system, preparing appropriate environment variables for the computer, preparing appropriate environment variables for the computer, and preparing appropriate initialization files for the loaded software.

When installing hardware and software onto multiple information handling systems in a manufacturing environment, identifying a unique software or hardware order across multiple information handling systems is desirable. A software order is unique if all the software parts and parameters that are installed in a system are unique in combination. A hardware order is unique when all of the hardware parts of that order are unique in combination.

### SUMMARY OF THE INVENTION

In accordance with the present invention, a system for identifying and calculating unique orders is set forth. The system identifies unique software and hardware orders across multiple systems within the manufacturing environment.

Systems with the same software parts are considered the same order and are assigned the same unique part information value. Systems with the same hardware parts are identified and assigned the same unique part information value. Associating the unique part information values with individual part identifiers enables metrics regarding the unique part information to be easily generated.

Such a method advantageously allows testing efforts to focus on hardware and software that is ordered in combination with each other. Combinations with higher take rates can be tested more extensively than combinations with lower take rates during testing efforts. Such a testing strategy applies the largest amount of the testing resource to the combinations which are most often ordered. Combinations with no take rate can be eliminated from testing.

In one embodiment, the invention relates to a method for identifying unique orders. The method includes gathering part information for an ordered system, concatenating a string of the part information data for a given order type, and calculating a unique order information value from the string of part information data.

In another embodiment, the invention relates to an apparatus for identifying unique orders. The apparatus includes means for gathering part information for an ordered system, means for concatenating a string of the part information data for a given order type, and means for calculating a unique order information value from the string of part information data.

In another embodiment, the invention relates to an information handling system for identifying unique orders. The information handling system includes a processor and a memory coupled to the processor. The memory stores modules for gathering part information for an ordered system, concatenating a string of the part information data for a given order type, and calculating a unique order information value from the string of part information data.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of a system for installing software.

FIG. 2 shows a block diagram of a plurality of manufacturing sites providing information relating to orders.

FIG. 3 shows a flow chart of the operation of a system for identifying unique orders.

FIG. 4 shows a system block diagram of an information handling system having a unique order configuration.

### DETAILED DESCRIPTION

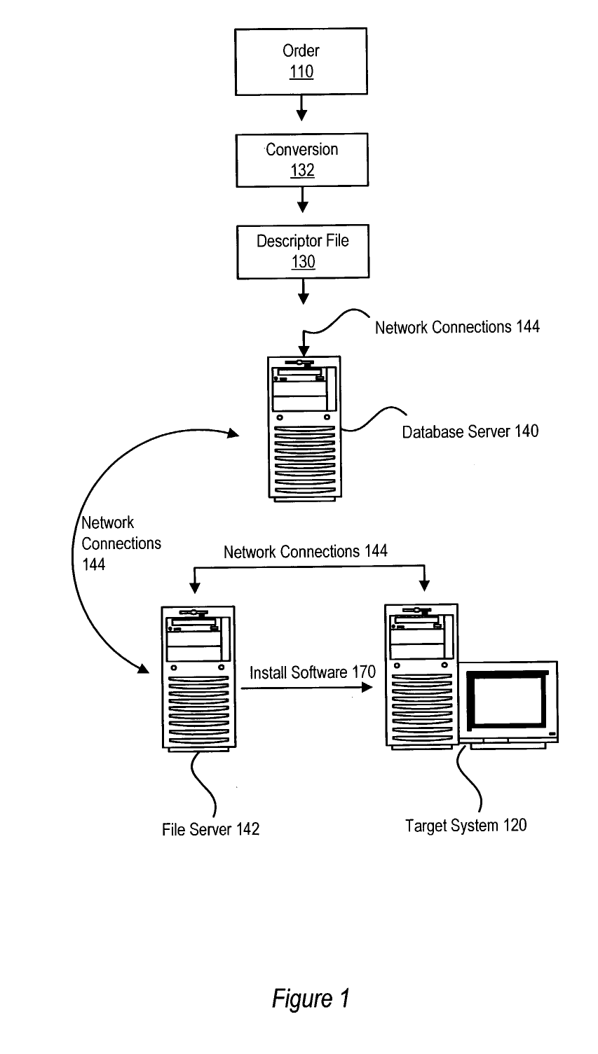

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is desirable to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 110.

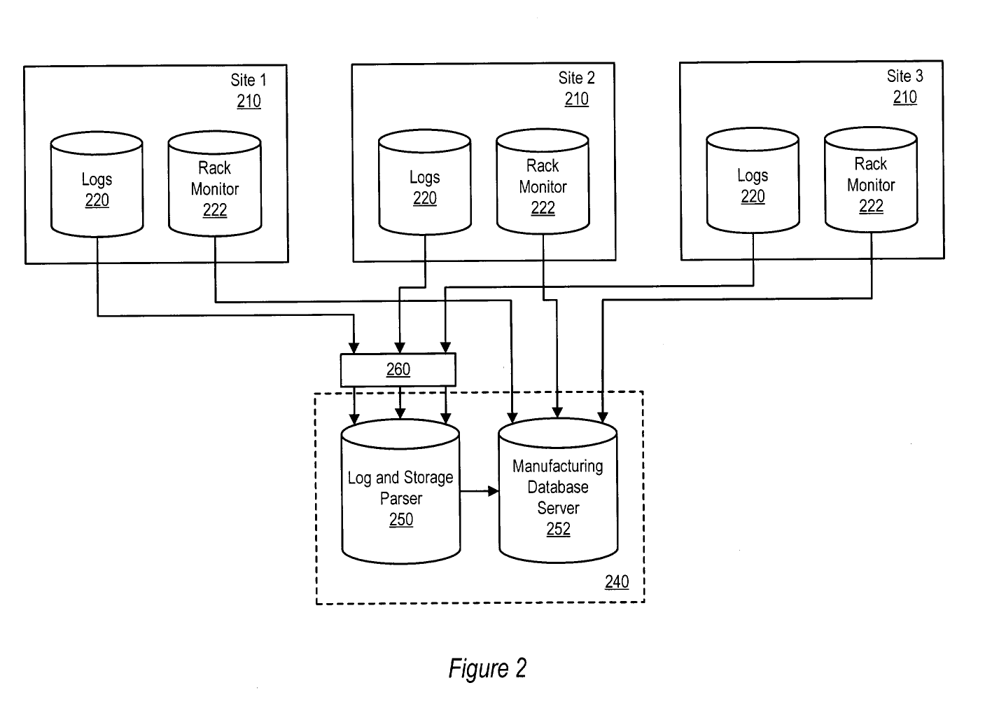

Referring to FIG. 2, a block diagram of a plurality of manufacturing sites providing information relating to orders is shown. More specifically, the plurality of manufacturing sites 210 each include a respective log database 220 and burn rack monitor database 222. Information from the log databases 220 and the burn rack monitor databases 222 are provided to an order storage system 240. The order storage system includes a log storage and parser server 250 and a manufacturing database server 252. The log storage and parser server 250 and the manufacturing database server 252 may be located on one or more servers. The log storage and parser server 250 receives information from the log databases 220 and the manufacturing database server 252 receives information from the burn rack monitor database 222. The information that is provided to the log storage and parser database 250 passes through a system for calculating and identifying unique orders 260.

The system for calculating and identifying unique orders 260 packages a plurality of different system configurations in a unique and easily identifiable identifier. Providing a unique and easily identifiable identifier for each unique order configuration enables analysis of the order configuration to determine the frequency of certain order configurations as well as ranking of certain order configurations. Such identification and ranking enables pre-combination of certain commonly ordered configurations so as to expedite the manufacturing and loading process.

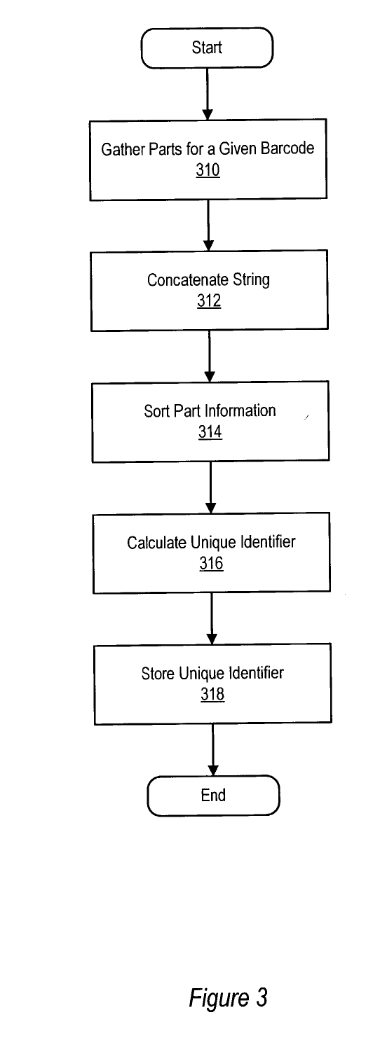

Referring to FIG. 3, a flow chart of the operation of the system for calculating and identifying unique orders 260 is shown. More specifically, the system for calculating and identifying unique orders 260 starts operation by gathering the part information for a given system barcode at step 310. The part information includes software part information and hardware part information. The software part information includes the software part (referred to as an SRV) and a part number that functions as a passed parameter to a software part (referred to as the infopart) for the software. Infoparts perform functional variations based upon the existence of an infopart in the order. The hardware part information includes the item, the sequence number and the detailed description of the hardware. The sequence number represents the slot of the hardware part. The sequence number is present when more than one of the same hardware component is present in a system (e.g., more than one hard drive, memory chip NIC card, etc. in a system).

After the part information is gathered at step 310, then the system concatenates a string containing all of the part information for a given order type at step 312. The given order type includes hardware order information, software order information, informational order information and base part order information. More specifically, the software order information includes the SRV of the order, the information order information includes the infopart, the hardware order information includes the item, sequence number and detailed description and the base part order information includes images of the SRVs contained within the base parts list.

After the string is concatenated at step 312, the string of part information is sorted at step 314. The string of part information is sorted by any known consistent sorting routine such that the part information is presented in a consistent order across the part information records.

After the string of part information is sorted at step 314, a unique order information value is calculated for the sorted string of part information. The unique order information value is calculated, for example, by calculating a unique integer for each type of unique order information. More specifically, a cyclical redundancy checking (CRC) algorithm is applied to the sorted part information and an integer value is provided by the algorithm.

The CRC algorithm may be any known CRC algorithm. Known CRC techniques ensure the accuracy of transmitting digital data. The transmitted digital data messages are divided into predetermined lengths which, used as dividends, are divided by a fixed divisor. The remainder of the calculation is appended onto and sent with the message. Upon receipt of the transmitted digital data message, the remainder is recalculated. If the remainder does not match the transmitted remainder, an error is detected. In the preferred embodiment, the CRC algorithm is used to calculate a unique order information value which reflects unique sorted part information.

After the unique order information value is calculated, this value is stored within the manufacturing database server 252 at step 318. The unique order information value is associated with an associated barcode. Storing the unique information value in the database server 252 at the barcode level facilitates and speeds analysis of groupings, averages, sums etc. of the unique order information because the number of records in the groups is significantly less at the barcode level than at the individual part per barcode level.

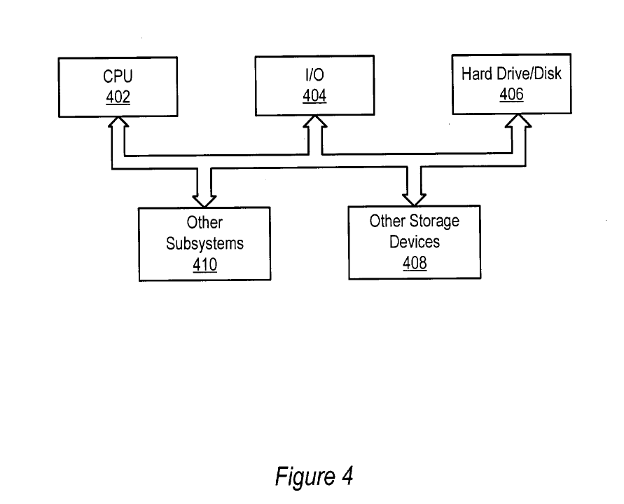

Referring to FIG. 4, a system block diagram of an information handling system 400 which has parts installed which are identified by the unique order information is shown. The information handling system includes a processor 402, input/output (I/O) devices 404, such as a display, a keyboard, a mouse, and associated controllers, a hard disk drive 406, and other storage devices 408, such as a floppy disk and drive and other memory devices, and various other subsystems 410, all interconnected via one or more buses 412. The software that is installed according to the unique order information methodology is installed onto hard disk drive 406. Alternately, the software may be installed onto any appropriate non-volatile memory. The non-volatile memory may also store the information relating to which unique parts were installed on the information handling system. Accessing this information enables a user to have additional systems corresponding having the unique part combinations to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

### OTHER EMBODIMENTS

Other embodiments are within the following claims.

Also for example, the above-discussed embodiments include software modules that perform certain tasks. The software modules may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for identifying unique orders, comprising:
gathering part information for an ordered system;
concatenating a string of the part information data for a given order type; and,
calculating a unique order information value from the string of part information data.

2. The method of claim 1, further comprising:
sorting the part information data for the ordered system.

3. The method of claim 1, wherein
a given order type includes at least one of hardware order information, software order information, informational order information and base part order information.

4. The method of claim 1, wherein:
the calculating a unique order information value includes calculating a unique integer for each type of unique order information.

5. The method of claim 4, wherein:
the unique integer for the string of part information data is stored within a manufacturing database server.

6. The method of claim 1, wherein:
the calculating a unique order information value includes applying a cyclical redundancy checking (CRC) algorithm to the string of part information data to generate a CRC value corresponding to the string of part information data.

7. The method of claim 6, wherein:
the CRC value corresponding to the string of part information data is stored within a manufacturing database server.

8. An apparatus for identifying unique orders, comprising:
means for gathering part information for an ordered system;
means for concatenating a string of the part information data for a given order type; and,
means for calculating a unique order information value from the string of part information data.

9. The apparatus of claim 8, further comprising:
means for sorting the part information data for the ordered system.

10. The apparatus of claim 8, wherein
a given order type includes at least one of hardware order information, software order information, informational order information and base part order information.

11. The apparatus of claim 8, wherein:
the means for calculating a unique order information value includes means for calculating a unique integer for each type of unique order information.

12. The apparatus of claim 11, wherein:
the unique integer for the string of part information data is stored within a manufacturing database server.

13. The apparatus of claim 8, wherein:
the means for calculating a unique order information value includes means for applying a cyclical redundancy checking (CRC) algorithm to the string of part information data to generate a CRC value corresponding to the string of part information data.

14. The apparatus of claim 13, wherein:
the CRC value corresponding to the string of part information data is stored within a manufacturing database server.

15. An information handling system for identifying unique orders, comprising:
a processor;
a memory coupled to the processor, the memory storing modules for:
gathering part information for an ordered system;
concatenating a string of the part information data for a given order type; and,
calculating a unique order information value from the string of part information data.

16. The information handling system of claim 15, wherein the memory stores a module for:
sorting the part information data for the ordered system.

17. The information handling system of claim 15, wherein
a given order type includes at least one of hardware order information, software order information, informational order information and base part order information.

18. The information handling system of claim 15, wherein:
the calculating a unique order information value includes calculating a unique integer for each type of unique order information.

19. The information handling system of claim 18, wherein:
the unique integer for the string of part information data is stored within a manufacturing database server.

20. The information handling system of claim 15, wherein:
the calculating a unique order information value includes applying a cyclical redundancy checking (CRC) algorithm to the string of part information data to generate a CRC value corresponding to the string of part information data.

21. The information handling system of claim 20, wherein:
the CRC value corresponding to the string of part information data is stored within a manufacturing database server.
